(19) United States
(12) Patent Application Publication
(10) Pub. No.: US 2025/0235856 A1
(43) Pub. Date: Jul. 24, 2025

(54) MOLYBDENUM AMINE COMPLEX CATALYST AND PREPARATION METHOD THEREFOR AND USE THEREOF

(71) Applicants: CHINA SHENHUA COAL TO LIQUID AND CHEMICAL CO., LTD, Beijing (CN); CHINA SHENHUA COAL TO LIQUID AND CHEMICAL SHANGHAI RESEARCH INSTITUTE, Shanghai (CN)

(72) Inventors: Dao LI, Shanghai (CN); Geling YANG, Shanghai (CN); Shansong GAO, Shanghai (CN); Hongxue WANG, Shanghai (CN); Jing XIE, Shanghai (CN)

(21) Appl. No.: 18/848,397

(22) PCT Filed: Jan. 9, 2023
(86) PCT No.: PCT/CN2023/071348

§ 371 Date: Sep. 18, 2024

(51) Int. Cl. B01J 31/18; B01J 37/04; C10G 1/08

(52) U.S. Cl. CPC B01J 31/1805; B01J 37/04; C10G 1/083

(57) ABSTRACT

The present disclosure discloses a molybdenum amine complex catalyst and a preparation method and use thereof, wherein, the method for preparing the molybdenum amine complex catalyst comprises the following steps: in the presence of a dispersion medium hydrocarbon oil, reacting a hexavalent molybdenum compound with at least one aliphatic amine compound having C4 or more carbon atoms to obtain an active metal catalyst precursor, and uniformly dispersing the active metal catalyst precursor in the dispersion medium hydrocarbon oil to obtain the molybdenum amine complex catalyst. When the molybdenum amine complex catalyst of the present disclosure is applied to the direct coal liquefaction reaction, it can significantly improve the conversion rate of coal and the conversion rate of asphaltene and preasphaltene to oil, allowing the required reaction pressure to be significantly reduced while achieving an oil yield comparable to that of the iron-based catalyst.

### CROSS-REFERENCE TO RELATED APPLICATIONS

This application is a U.S. National Stage of International Patent Application No. PCT/CN2023/071348 filed Jan. 9, 2023, which is incorporated by reference herein as if reproduced in its entirety.

### TECHNICAL FIELD

The present disclosure relates to the technical field of direct coal liquefaction, in particular to a molybdenum amine complex catalyst and a preparation method and use thereof.

### BACKGROUND

Direct coal liquefaction is a complex physical and chemical process with numerous influencing factors. Among them, since the reaction rate, conversion rate, oil yield, gas yield, and hydrogen consumption in coal liquefaction are greatly affected by the activity and selectivity of a catalyst, the catalyst is an effective means to improve coal liquefaction efficiency and energy utilization ratio, and to realize the commercial value of direct coal liquefaction and maintain its competitiveness. How to develop and design catalysts with high catalytic activity, good selectivity, and low cost has always been a hot research topic of direct coal liquefaction.

Compounds including elements such as Mo, Ni, and Fe, etc., are effective hydrogenation catalysts and are widely used in direct coal hydrogenation liquefaction reactions. Among them, iron-based catalysts have high hydrogenation activity towards olefins and free radicals, relatively low cost, and are the “cheap and disposable” type of catalysts, making them the most valued coal liquefaction hydrogenation catalysts. However, the iron-based catalysts have moderate catalytic activity towards the cracking of aromatic rings, methylene bridged bonds, and alkyl C—C, as well as the removal of heteroatoms such as S, N, O, etc. Transition metals such as Mo and Ni, etc., not only have high hydrogenation activity but also high ability to remove heteroatoms, however they are relatively expensive and are mainly used in solvent hydrogenation and hydrogenation reactions of coal liquefaction products. Although the iron-based catalysts are inexpensive and suitable for use as disposable catalysts for direct coal liquefaction, their catalytic activity is relatively low. Research has shown that metal molybdenum and its molybdate not only have better catalytic activity than iron-based catalysts, but also have certain selectivity towards the chemical bond cleavage between Car-Cal bonds and Car-O bonds in the macromolecular structure of coal, which can further improve the catalytic efficiency and selectivity of direct coal liquefaction. Since the 1920s, a molybdenum sulfide catalyst has been used to significantly improve the efficiency of primary coal liquefaction and to upgrade the coal liquefaction products. It is generally believed that the main active ingredient for primary coal liquefaction is MoS₂, which is formed by the decomposition of molybdenum salts or their organic complexes as precursors under liquefaction conditions. However, further research is still needed to improve the formation and performance of the active state.

CN102895973B discloses a composite catalyst for direct coal liquefaction and a preparation method therefor, which uses natural laterite nickel ore as a catalyst, or uses a catalyst made by using laterite nickel ore and other iron ores as raw materials and artificially supporting with active metal components such as cobalt, molybdenum, and nickel, etc. In this method, physical grinding is performed to obtain fine powder with a particle size of 10 nm to 500 μm from laterite nickel ore to improve the dispersion of the catalyst. When mechanical grinding is used to reduce the particle size of the catalyst powder, there is a significant consumption of power and materials in the grinding equipment, resulting in a significant increase in the grinding cost of the catalyst, which is not cost-effective. Moreover, in this method, active metals such as cobalt, molybdenum, and nickel, etc., are added for supporting before the co-precipitation reaction. These expensive non-ferrous metals will be lost with the filtrate during the filtration and washing processes, making it difficult to effectively retain them, greatly reducing the use efficiency of non-ferrous metals.

CN200710032428.4 discloses an organic complexed iron, cobalt, molybdenum, and boron catalyst, which is a liquid catalyst. The catalyst disclosed therein is limited in its applicability to coal types, and contains too many active components of the catalyst, making it difficult to prepare.

### BRIEF SUMMARY

In view of the above, the main object of the present disclosure is to provide a molybdenum amine complex catalyst and a preparation method therefor and use thereof. The molybdenum amine complex catalyst can significantly improve the conversion rate of coal and the conversion rate of asphaltene and preasphaltene to oil when applied in direct coal liquefaction reaction, allowing the required reaction pressure to be significantly reduced while achieving an oil yield comparable to that of the iron-based catalyst.

To achieve the above-mentioned object of the present disclosure, a first aspect of the present disclosure provides a method for preparing a molybdenum amine complex catalyst, comprising the steps of: reacting a hexavalent molybdenum compound with at least one aliphatic amine compound having C4 or more carbon atom in the presence of a dispersion medium hydrocarbon oil to obtain an active metal catalyst precursor, and uniformly dispersing the active metal catalyst precursor in the dispersion medium hydrocarbon oil to obtain the molybdenum amine complex catalyst.

A second aspect of the present disclosure provides a molybdenum amine complex catalyst prepared by the above method.

A third aspect of the present disclosure provides a molybdenum amine complex catalyst for direct coal liquefaction, comprising the molybdenum amine complex catalyst uniformly dispersed in a direct liquefaction circulating solvent.

A fourth aspect of the present disclosure provides a coal oil slurry for direct coal liquefaction, comprising a molybdenum amine complex catalyst as well as coal powder and a sulfur source, uniformly dispersed in a direct liquefaction circulating solvent.

A fifth aspect of the present disclosure provides a method for direct coal liquefaction, comprising: in the presence of a sulfur source and a molybdenum amine complex catalyst uniformly dispersed in a direct liquefaction circulating solvent, subjecting the coal powder to a direct coal liquefaction reaction.

Compared with the prior art, the present disclosure has the following advantages:
in the present disclosure, a hexavalent molybdenum compound is reacted with at least one aliphatic amine compound having C4 or more carbon atoms to obtain an active metal catalyst precursor, meanwhile the active metal catalyst precursor is uniformly dispersed in the dispersion medium hydrocarbon oil to obtain a molybdenum amine complex catalyst; the present disclosure uses dispersion medium hydrocarbon oil as the catalyst matrix oil, which can achieve high dissolution and dispersion of the catalyst in the coal oil slurry, while the high dispersion of the catalyst in turn directly affects the effect of the coal liquefaction reaction and can fully contact with the reactive coal; moreover, the molybdenum amine complex catalyst obtained in the present disclosure has a mass percentage content of molybdenum of no less than 8%, and good stability and no delamination.

The method for preparing a catalyst in the present disclosure is simple, and there are no limitations on the types of coal to which the catalyst is applicable. Different types of coal will not increase the difficulty of direct coal liquefaction, and can achieve better coal conversion rate, the applicability is good.

The iron-based catalyst referred to herein includes Fe₂O₃, FeS₂, and FeOOH, etc., which can be used as catalysts for direct liquefaction. The iron-based catalyst is converted into the active phase of pyrrhotite Fe₁₋ₓS under the vulcanized state in the direct liquefaction reaction, playing a catalytic role. Compared to the above iron-based catalyst in the direct coal liquefaction reaction, the molybdenum amine complex catalyst of the present disclosure can significantly improve the conversion rate of coal and the conversion rate of asphaltene/preasphaltene to oil, allowing the required reaction pressure to be significantly reduced while achieving an oil yield comparable to that of the iron-based catalyst, for example, reduced by 6-8 MPa.

Other features and advantages of the present disclosure will be explained in detail subsequently through specific embodiments.

### DESCRIPTION OF DRAWINGS

FIG. 1 shows the infrared spectrum of the molybdenum amine complex prepared in Example 1 of the present disclosure.

### DETAILED DESCRIPTION

This application will be further explained below in conjunction with the embodiments, however this application is not limited to the listed embodiments and should also include equivalent improvements and variations of the technical solution as defined in the claims attached to this application.

The endpoints and any values disclosed herein are not limited to the exact range or value, and such ranges or values should be understood to include values close to such ranges or values. For numerical ranges, the endpoint values of each range, the endpoint values of each range and individual point values, and individual point values, can be combined with each other to form one or more new numerical ranges, which should be considered to be specifically disclosed herein.

In a first aspect, the present disclosure provides a method for preparing a molybdenum amine complex catalyst, comprising the steps of: reacting a hexavalent molybdenum compound (A) with at least one aliphatic amine compound having C4 or more carbon atoms (B) in the presence of a dispersion medium hydrocarbon oil to obtain an active metal catalyst precursor (C), and uniformly dispersing the active metal catalyst precursor (C) in the dispersion medium hydrocarbon oil (D) to obtain the molybdenum amine complex catalyst.

The inventors of the present disclosure have found in the researches that the structure and properties of the precursor of a catalyst greatly affect the formation and performance of the active state. It is an important research direction in the field of direct liquefaction catalysis to study which precursor catalyst can be effectively converted into the active state, effectively achieving the goals of improving oil yield, reducing the reaction severity, tending to moderate reaction conditions, and significantly reducing the coal liquefaction costs.

In the present disclosure, preferably, the hexavalent molybdenum compound is one or more selected from oxides or metal salts of hexavalent molybdenum, including but not limited to sodium molybdate, potassium molybdate, diamine molybdate, ammonium dimolybdate, ammonium tetramolybdate, ammonium heptamolybdate, and molybdenum trioxide, etc. The aliphatic amine compound (B) is substituted onto the hexavalent molybdenum compound using the variable valency of molybdenum.

In the present disclosure, preferably, the at least one aliphatic amine compound having C4 or more carbon atoms (B) is selected from C4-C20 aliphatic diamine, including but not limited to one or more of dibutylamine, bis(ethylhexyl)amine, didodecylamine, and ditridecylamine; further, the dialkylamine used is preferably ditridecylamine. The inventors of the present disclosure have found in the researches that ditridecylamine has good reactivity and compatibility with molybdenum, resulting in a higher conversion rate of a hexavalent molybdenum compound to target molybdenum amine complex and a higher content of molybdenum in the target product.

In the present disclosure, preferably, the dispersion medium hydrocarbon oil (D) is a mineral oil with low viscosity (such as kinematic viscosity of 30 mm²/s or less at 20° C.) and low content of impurity, such as paraffin oil and naphthenic oil. When selecting the types of the dispersion medium hydrocarbon oil (D) mentioned above in the present disclosure, the main considerations are viscosity and naphthene content. Generally, the dispersion medium hydrocarbon oil (D) needs to maintain a certain fluidity, and thus the viscosity cannot be too high, meanwhile considering the application environment of the molybdenum amine complex catalyst prepared therefrom, it is also necessary to select a type of dispersion medium hydrocarbon oil (D) with good intersolubility with gasoline/diesel. For example, when a direct liquefaction product oil rich in naphthene is used, the catalyst can be sufficiently dissolved and dispersed therein, and when the molybdenum amine complex catalyst obtained by using direct liquefaction product oil is applied to the direct coal liquefaction reaction, it can achieve better dispersion due to the like dissolves like property, promoting the good proceeding of the direct liquefaction reaction; preferably, a naphthene content of the dispersion medium hydrocarbon oil (D) is more than 60%, further preferably 65% to 98%.

In a specific example, the dispersion medium hydrocarbon oil (D) is a diesel rich in naphthene produced by a direct coal liquefaction plant, with a distillation range of 150-250° C., a density at 20° C. of between 0.8 g/cm³ and 0.95 g/cm³, and a kinematic viscosity at 20° C. of no more than 20 mm²/s, with a naphthene content of between 85% and 98%.

In the present disclosure, the hexavalent molybdenum compound (A) and the aliphatic amine compound (B) are preferably reacted at a temperature between 40° C. and 100° C. Furthermore, the reaction temperature is controlled to 65° C. to 80° C. Within this range, the conversion rate of the raw material molybdenum compound to the target molybdenum amine complex can be further improved; and the reaction temperature is further preferably controlled at 75±1° C.

It can be understood that before the hexavalent molybdenum compound (A) and the aliphatic amine compound (B) are mixed and reacted, in order to make the hexavalent molybdenum compound (A) more uniformly dispersed in the reaction system, the hexavalent molybdenum compound (A) can be dispersed in the dispersion medium hydrocarbon oil (D) firstly, or with the aid of stirring. In a specific example, the hexavalent molybdenum compound (A), deionized water, and dispersion medium hydrocarbon oil (D) are mixed and stirred for a certain period of time to fully disperse the hexavalent molybdenum compound (A) therein. In another specific example, the hexavalent molybdenum compound (A), deionized water, and dispersion medium hydrocarbon oil (D) are uniformly dispersed under the emulsifying action of an emulsifier.

In the present disclosure, an exothermic reaction is carried out when the hexavalent molybdenum compound (A) is mixed with the aliphatic amine compound (B). Preferably, the aliphatic amine compound (B) can be slowly added dropwise to the hexavalent molybdenum compound (A) in not more than 1 hour, preferably in 10 minutes to 40 minutes at a constant speed, so that the hexavalent molybdenum compound (A) and the aliphatic amine compound (B) can be uniformly mixed and completely reacted. Preferably, the molar ratio of the hexavalent molybdenum compound (A) to the aliphatic amine compound (B) is 2˜3.5:1, further preferably 2˜3:1, such as 2.0:1, 2.1:1, 2.2:1, 2.3:1, 2.4:1, 2.5:1, 2.6:1, 2.7:1, 2.8:1, 2.9:1, 3.0:1, 3.1:1, 3.2:1, 3.3:1, 3.4:1, 3.5:1 or other numerical values within this range. When the molar ratio is within the above preferred range, the molybdenum content in the molybdenum amine complex is relatively high, such as approaching 10%.

It can be understood that after the hexavalent molybdenum compound (A) and the aliphatic amine compound (B) are mixed and reacted, the moisture in the catalyst product can be removed as needed. For example, in a specific example, it is distilled under the vacuum degree of −0.080 MPa to −0.099 MPa at the temperature of 97˜102° C. until there is no moisture and the fractions flow out, thereby obtaining an emulsion-like homogeneous molybdenum amine complex catalyst.

In a second aspect, the present disclosure provides a molybdenum amine complex catalyst prepared by the above method, wherein it has a molybdenum content of not less than 8% by mass, and good stability without delamination.

In a third aspect, the present disclosure provides a molybdenum amine complex catalyst for direct coal liquefaction, comprising the molybdenum amine complex catalyst uniformly dispersed in a direct liquefaction circulating solvent.

It can be understood that according to the actual dispersion needs, the molybdenum amine complex catalyst can be fully mixed with the direct liquefaction circulating solvent under the emulsifying action of an emulsifier, so that the catalyst is fully dispersed in the solvent. Preferably, the molybdenum amine complex catalyst is added in an amount such that the mass ratio of Mo to dry coal is 0.05% to 1%, and within this range, a better catalytic effect can be achieved. Further, the molybdenum amine complex catalyst is added in an amount such that the mass ration of Mo to dry coal is 0.1% to 0.3%, such as 0.1%, 0.15%, 0.2%, 0.25%, 0.3%, or other values within this range.

In a fourth aspect, the present disclosure provides a coal oil slurry for direct coal liquefaction, comprising a molybdenum amine complex catalyst coal powder and a sulfur source for reaction, uniformly dispersed in a direct liquefaction circulating solvent. All three are fully mixed to a uniform state and formulated into the coal oil slurry for reaction.

In the present disclosure, the sulfur source is a sulfur-containing compound, such as elemental sulfur or carbon disulfide, etc., preferably sulfur is added in an amount such that an atomic ratio of S to Mo is 1 to 3. In the direct coal liquefaction reaction, the active state in which the molybdenum catalyst works is MoS₂, therefore it is necessary to ensure an enough amount of S to convert the precursor into an active state. Further, sulfur is added in an amount such that an atomic ratio of S to Mo is 2 to 2.5, such as 2.0, 2.1, 2.2, 2.3, 2.4, 2.5 or other values within this range.

In a fifth aspect, the present disclosure provides a method for direct coal liquefaction, comprising: in the presence of a sulfur source and a molybdenum amine complex catalyst uniformly dispersed in a direct liquefaction circulating solvent, subjecting the coal powder to a direct coal liquefaction reaction.

In the present disclosure, preferably, the above direct coal liquefaction reaction is carried out under the conditions of a reaction temperature of 450˜460° C., a reaction pressure of 10-15 MPa, and a reaction residence time of 0.5 hour to 2 hours, to obtain the gas-phase and liquid-phase products, which are subjected to yield weighing and composition analysis to calculate the direct liquefaction conversion rate and oil yield.

Further, the above direct coal liquefaction reaction is carried out at a temperature of 455±2° C. and a reaction pressure of 12±0.2 MPa, with a reaction residence time of 1±0.1 hours. The above reaction temperature affects the pyrolysis degree of coal into small molecules.

In the direct coal liquefaction reaction, reducing the reaction pressure can reduce both the reaction severity and the overall investment cost of the plant. However, generally speaking, reducing the reaction pressure will inevitably affect the reaction effects of conversion rate of coal and oil yield, etc. When the molybdenum amine complex catalyst of the present disclosure is applied to the direct coal liquefaction reaction, it solves the problem that it is unable to balance the above reaction pressure and reaction effect. That is, the present disclosure can significantly improve the conversion rate of coal and the conversion rate of asphaltene and preasphaltene to oil, allowing the required reaction pressure to be significantly reduced while achieving an oil yield comparable to that of the iron-based catalyst.

The present disclosure will be described in detail below through examples:

The coal powder used in the examples is mined from the Shenhua Shendong mining area, and the coal quality analysis is shown in Table 1. The coal samples are pre-ground to 74 μm or less for later use.

TABLE 1
Property Analysis of Shendong Coal

| Industrial analysis, | | | | | | | | | | Petrographic analysis, | | |
|---|---|---|---|---|---|---|---|---|---|---|---|---|
| w/% | | | | Elemental analysis, w_{daf}/% | | | | | | φ/% | | |
| M_{ad} | A_{d} | V_{daf} | FC_{daf} | C | H | O | N | S | n(H)/n(C) | Vitrinite | Inertinite | Exinite |
| 9.42 | 4.61 | 34.25 | 64.93 | 77.54 | 4.49 | 12.16 | 0.91 | 0.29 | 0.69 | 43.5 | 54.4 | 0.8 |

In Table 1, the meanings represented by each symbol and the measurement methods are shown below:

For the industrial analysis, M_{ad} refers to the air dry base moisture; Ad refers to the dry base ash; and V_{daf} refers to the dry, ash free volatile, which are measured in accordance with the methods in GB/T211-2017 and GB/T212-2008.

For the elemental analysis, FC_{daf} refers to the dry, ash free fixed carbon; and C, H, O, N, and S refer to the content of each element, respectively, which are measured in accordance with the methods in GB/T214-2007, GB/T476-2008 and GB/T19227-2008.

For the petrographic analysis, Vitrinite refers to the content of vitrinite; Inertinite refers to the content of inertinite; and Exinite refers to the content of exinite, which are measured in accordance with the methods in GB/T8899-2013.

Unless otherwise specified, other raw materials in the present disclosure can be obtained from commercially available sources.

The direct liquefaction circulating solvent used in the examples is an intermediate product during the coal liquefaction process. After partial hydrogenation of an aromatic hydrocarbon, it serves as the circulating solvent, a part of which is used as the solvent for formulating the coal oil slurry, and the other part is used to supply hydrogen to the direct liquefaction reaction. Analysis of main properties of the circulating solvent is shown in Table 2.

TABLE 2
Property Analysis of Circulating Solvent

| ρ²⁰/ | | PDQI/ | w/% | | | | |
|---|---|---|---|---|---|---|---|
| (g · cm⁻³) | ƒₐ | (mg · g⁻¹) | C | H | O | N | S |
| 0.9672 | 0.45 | 17.80 | 87.62 | 11.98 | 0.12 | 0.04 | 0.004 |

### Example 1

1 mol of molybdenum trioxide powder, 2 mol of deionized water, and 300 g of diesel produced by a direct liquefaction plant (properties and composition of which are shown in Table 3) were mixed, and then emulsified with an emulsifier for a certain period of time to fully disperse the molybdenum trioxide, then 0.5 mol of ditridecylamine was added dropwise in 30 minutes and reacted at 75° C. for 2 hours, the resulted reaction mixture was distilled at 100° C. and −0.099 KPa for 1 hour to remove moisture to give an organic molybdenum amine complex in which the molybdenum content was measured to be 10.08%.

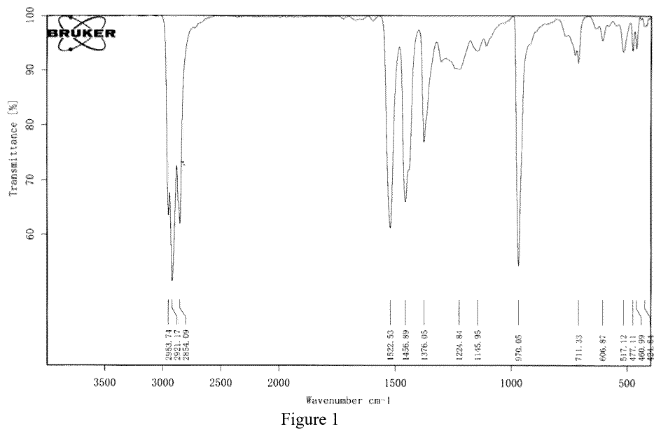

The infrared spectrum of the organic molybdenum amine complex is shown in FIG. 1. It can be seen from FIG. 1 that in the functional group region, a secondary amine characteristic peak appears near 3330 cm⁻¹, namely a N—H stretching absorption peak; there are absorption peaks at 2959 cm⁻¹ to 2837 cm⁻¹, which are absorptions caused by CH₂ asymmetric and symmetric stretching vibrations, respectively; C—C and C—N stretching vibrations occurs at 1536 cm⁻¹ to 968 cm⁻¹; the absorption peak at 732 cm⁻¹ belongs to the vibration of Mo—O group (in fingerprint region), and the peak appearing in the fingerprint region indicates that Mo—O has bound to the dialkylamine. In addition, after the reaction, there were no solid particles and all became liquid oil soluble, also indicating that MoO₃ has bound to the dialkylamine and replaced the H on the dialkylamine.

TABLE 3
Physical Properties and Composition of Coal Direct
Liquefaction Hydrogenation Upgraded Diesel

| | Coal direct liquefaction |
|---|---|
| Sample Name | hydrogenation upgraded diesel |
| Density at 20° C./(g/cm³) | 0.8314 |
| Kinematic viscosity at 20° C. (mm²/s) | 1.946 |
| Distillation range D86(actual | |
| measurement)/° C. | |
| Initial boiling point/5% | 155.4/176.1 |
| 10%/30% | 177.2/181.7 |
| 50%/70% | 187.4/195.7 |
| 90%/95% | 212.2/222.1 |
| Final boiling point | 235.3 |
| Composition and content of hydrocarbon | |
| fractions (m %) | |
| alkanes | 5.5 |
| Naphthenes | 93.0 |
| Monocyclic aromatic hydrocarbons | 1.2 |
| Bicyclic aromatic hydrocarbons | 0.3 |
| Total aromatic hydrocarbons | 1.5 |

0.71 g (with a mass ratio of Mo to dry coal powder of 0.25%) of the above organic molybdenum amine complex as catalyst was added to 42 g of the direct liquefaction circulating solvent, which was mixed uniformly by stirring thoroughly with an emulsifier, so that the catalyst was fully dispersed in the direct liquefaction circulating solvent, and a catalyst mixture was obtained.

28 g of dry coal powder was added to the high-pressure reactor, then the above catalyst mixture was added, and 0.047 g of powdered elemental S (with an atomic ratio of S to Mo of 2.3:1) was added. Hydrogen was charged until the pressure reached 6 MPa, the temperature of the high-pressure reactor was raised to 455° C. by programmed heating, and the average pressure during the reaction was 12.0 MPa (in the following experiments, the reaction pressures were all within the target pressure±0.03, which was a reasonable range of pressure fluctuations), then reacted at a constant temperature for 60 minutes. Gas-phase and liquid-phase products were obtained, which were subjected to yield weighing and composition analysis to calculate the performance data such as direct liquefaction conversion rate and oil yield, etc.

After the reaction was completed, gas-phase and liquid-solid phase products were obtained. Composition of the gas phase products was determined by gas chromatography, and the liquid-solid products were subjected to Soxhlet extraction with n-hexane and tetrahydrofuran sequentially, and the n-hexane soluble substances were defined as oil, while the tetrahydrofuran soluble substances were defined as asphaltene and preasphaltene; the remainder after the tetrahydrofuran insoluble substances were dried and calcinated at 815° C. in a muffle furnace for 6 hours was residual ash (RA); and the coal conversion rate (X), gas yield (G), hydrogen consumption (H), oil yield (O), and asphaltene (including preasphaltene and asphaltene, A) yield were calculated according to the following formulas:

$$\begin{matrix}X = 1 - ( T I - RA ) / {F}_{daf} \\ A = ( H I - TI ) / {F}_{daf} \\ H = ( H 0 - H 1 ) / {F}_{daf} \\ G = ( G 1 - H 1 ) / {F}_{daf} \\ O = X + H - G - W - A\end{matrix}$$

Wherein, F_{daf}: mass of anhydrous and ash-free base coal (in g);
HO: mass of hydrogen charged into the reactor before reaction (in g);
H1: mass of remaining hydrogen in the reactor after reaction (in g);
G1: mass of gas inside the reactor after reaction (in g);
HI: mass of n-hexane insoluble substances (in g);
TI: mass of tetrahydrofuran insoluble substances (in g);
RA: mass of remainders after the tetrahydrofuran insoluble substances were calcinated (in g);
H: hydrogen consumption;
G: gas yield;
W: water yield, the oxygen element in coal minus the oxygen elements in the gas products CO and CO₂, and then converted to the mass of water/F_{daf};
A: asphalt yield, mass difference between n-hexane insoluble substances and tetrahydrofuran insoluble substances/F_{daf};
O: oil yield.

### Example 2

The molybdenum amine complex catalyst was prepared in the same way as in Example 1.

0.57 g (with a mass ratio of Mo to dry coal powder of 0.2%) of the above catalyst was added to 42 g of the direct liquefaction circulating solvent, which was mixed uniformly by stirring thoroughly with an emulsifier, so that the catalyst was fully dispersed in the circulating solvent.

The above catalyst was used in the direct coal liquefaction method and the product was analyzed in the same way as in Example 1.

### Example 3

1 mol of molybdenum trioxide powder, 2 mol of deionized water, and 300 g of commercially available Karamay KN4010 naphthenic oil were mixed, and then emulsified with an emulsifier for a certain period of time to fully disperse the molybdenum trioxide, then 0.5 mol of ditridecylamine was added dropwise in 1 hour and reacted at 75° C. for 2 hours, the reaction mixture was distilled at 100° C. and −0.099 KPa for 1 hour to remove moisture to give a molybdenum amine complex catalyst, in which the molybdenum content was measured to be 9.54%.

0.66 g (with a mass ratio of Mo to dry coal powder of 0.25%) of the above catalyst was added to 42 g of the direct liquefaction circulating solvent, which was mixed uniformly by stirring thoroughly with an emulsifier, so that the catalyst was fully dispersed in the circulating solvent.

The above catalyst was used in the direct coal liquefaction method and the product was analyzed in the same way as in Example 1.

### Example 4

1 mol of molybdenum trioxide powder, 2 mol of deionized water, and 300 g of diesel produced by a direct liquefaction plant were mixed, and then emulsified with an emulsifier for a certain period of time to fully disperse the molybdenum trioxide, then 0.3 mol of didodecylamine was added dropwise in 1 hour and reacted at 75° C. for 2 hours, the reaction mixture was distilled at 100° C. and −0.099 KPa for 1 hour to remove moisture to give molybdenum amine complex catalyst, in which the molybdenum content was measured to be 9.63%.

0.73 g (with a mass ratio of Mo to dry coal powder of 0.25%) of the above catalyst was added to 42 g of the direct liquefaction circulating solvent, which was mixed uniformly by stirring thoroughly with an emulsifier, so that the catalyst was fully dispersed in the circulating solvent.

The above catalyst was used in the direct coal liquefaction method and the product was analyzed in the same way as in Example 1.

### Example 5

1 mol of molybdenum trioxide powder, 2 mol of deionized water, and 200 g of diesel produced by a direct liquefaction plant were mixed, and then emulsified with an emulsifier for a certain period of time to fully disperse the molybdenum trioxide, then 0.5 mol of didodecylamine was added dropwise in 1 hour and reacted at 65° C. for 2 hours, the reaction mixture was distilled at 100° C. and −0.099 KPa for 1 hour to remove moisture to give a molybdenum amine complex catalyst, in which molybdenum content was measured to be 8.33%.

0.84 g (with a mass ratio of Mo to dry coal powder of 0.25%) of the above catalyst was added to 42 g of the direct liquefaction circulating solvent, which was mixed uniformly by stirring thoroughly with an emulsifier, so that the catalyst was fully dispersed in the circulating solvent.

The above catalyst was used in the direct coal liquefaction method and the product was analyzed in the same way as in Example 1.

### Example 6

Except that 1 mol of molybdenum trioxide powder was replaced by 1 mol of sodium molybdate powder, the same operations were carried out as in Example 1, in which the molybdenum content in the molybdenum amine complex catalyst was measured to be 8.16%.

### Example 7

Except that 1 mol of ditridecylamine was replaced by 1 mol of bis(ethylhexyl)amine, the same operations were carried out as in Example 1, in which the molybdenum content in the molybdenum amine complex catalyst was measured to be 7.94%.

### Example 8

Except that the molybdenum trioxide was reacted with ditridecylamine at 80° C. for 2 hours, the same operations were carried out as in Example 1, in which the molybdenum content in the molybdenum amine complex catalyst was measured to be 9.72%.

### Example 9

Except that the molybdenum amine complex catalyst was added in an amount such that the mass ratio of Mo to dry coal was 0.05%, the same operations were carried out as in Example 1.

### Example 10

Except that the molybdenum amine complex catalyst was added in an amount such that the mass ratio of Mo to dry coal was 0.1%, the same operations were carried out as in Example 1.

### Example 11

The molybdenum amine complex catalyst was prepared in the same way as in Example 1.

0.71 g (with a mass ratio of Mo to dry coal powder of 0.25%) of the above organic molybdenum amine complex as catalyst was added to 42 g of the direct liquefaction circulating solvent, which was mixed uniformly by stirring thoroughly with an emulsifier, so that the catalyst was fully dispersed in the direct liquefaction circulating solvent, and a catalyst mixture was obtained.

28 g of dry coal powder was added to the high-pressure reactor, then the above catalyst mixture was added, and then 0.047 g of powdered elemental S (with an atomic ratio of S to Mo of 2.3:1) was added. Hydrogen was charged until the pressure reached 5 MPa, the temperature of the high-pressure reactor was raised to 460° C. by programmed heating, and the average pressure during the reaction was 10.01 MPa, then reacted at a constant temperature for 60 minutes. Gas-phase and liquid-phase products were obtained, which were subjected to yield weighing and composition analysis to calculate the performance data such as direct liquefaction conversion rate and oil yield, etc.

### Example 12

The molybdenum amine complex catalyst was prepared in the same way as in Example 1.

0.71 g (with a mass ratio of Mo to dry coal powder of 0.25%) of the above organic molybdenum amine complex as catalyst was added to 42 g of the direct liquefaction circulating solvent, which was mixed uniformly by stirring thoroughly with an emulsifier, so that the catalyst was fully dispersed in the direct liquefaction circulating solvent, and a catalyst mixture was obtained.

28 g of dry coal powder was added to the high-pressure reactor, then the above catalyst mixture was added, and then 0.047 g of powdered elemental S (with an atomic ratio of S to Mo of 2.3:1) was added. Hydrogen was charged until the pressure reached 8 MPa, the temperature of the high-pressure reactor was raised to 450° C. by programmed heating, and the average pressure during the reaction was 15.02 MPa, then reacted at a constant temperature for 60 minutes. Gas-phase and liquid-phase products were obtained, which were subjected to yield weighing and composition analysis to calculate the performance data such as direct liquefaction conversion rate and oil yield, etc.

### Comparative Example 1

1 mol of molybdenum trioxide powder, and 2 mol of deionized water were mixed, and then 0.5 mol of ditridecylamine was added dropwise in 30 minutes and reacted at 75° C. for 2 hours, the reaction mixture was distilled at 100° C. and −0.099 KPa for 1 hour to remove moisture to give an organic molybdenum amine complex, in which the molybdenum content was measured to be 18.32%.

The above catalyst was used in the direct coal liquefaction method and the product was analyzed in the same way as in Example 1.

The organic molybdenum amine complex obtained in this comparative example was in a powder form due to the absence of the dispersion medium hydrocarbon oil. Although it had high content of molybdenum, its oil solubility and dispersibility in the direct liquefaction coal oil slurry were not as good as the molybdenum amine complex product obtained in Example 1, which directly affected its catalytic performance for direct liquefaction reactions.

### Comparative Example 2

The molybdenum source of the catalyst was powder molybdenum hexacarbonyl. The coal oil slurry of the catalyst was prepared as follows: 0.2 g of powder molybdenum hexacarbonyl (with a mass ratio of Mo to dry coal powder of 0.25%) was thoroughly mixed with 42 g of circulating solvent, the thus obtained mixture was stirred uniformly, then 28 g of coal powder and 0.047 g of sulphur powder were added to the mixture, mixed thoroughly and stirred uniformly, then added to the high-pressure reactor.

The high-pressure reactor evaluation method and product analysis method of the catalyst were the same as those in Example 1.

### Comparative Example 3

The catalyst was selected as the hydrated iron oxide (FeOOH) catalyst used in the direct liquefaction demonstration plant, the catalyst had an iron content of 5.95%, the iron catalyst was added in an amount such that the mass ratio of Fe to dry coal powder was 1%, and S was added in an amount such that the atomic ratio of S to Fe was 2:1. The coal oil slurry of iron-based catalyst was prepared as follows: 5.41 g of the hydrated iron oxide catalyst (including 4.58 g of coal powder therein), 23.42 g of dry coal powder, 42 g of circulating solvent, and 0.32 g of sulphur powder were thoroughly mixed and stirred uniformly to prepare the coal oil slurry of iron-based catalyst, which was added to a high-pressure reactor.

The high-pressure reactor evaluation method and product analysis method of the catalyst were the same as those in Example 1.

### Comparative Example 4

The catalyst was selected as the hydrated iron oxide catalyst used in the direct liquefaction demonstration plant, the catalyst had an iron content of 5.95%, the iron catalyst was added in an amount such that the mass ratio of Fe to dry coal powder was 1%, and S was added in an amount such that the atomic ratio of S to Fe was 2:1. The coal oil slurry of iron-based catalyst was prepared as follows: 5.41 g of the hydrated iron oxide catalyst (including 4.58 g of coal powder therein), 23.42 g of dry coal powder, 42 g of circulating solvent, and 0.32 g of sulphur powder were thoroughly mixed and stirred uniformly to prepare the coal oil slurry of iron-based catalyst, which was added to a high-pressure reactor.

The reaction pressure in the high-pressure reactor evaluation method of the catalyst was 19 MPa, and the remaining reaction conditions and the product analysis method were the same as those in Example 1.

The data of reaction pressure and yield test results of the above examples are shown in Table 4.

TABLE 4
Evaluation Results of Direct Coal Liquefaction Performance
for Examples and Comparative examples

| | Reaction pressure, | Conversion rate of | |
|---|---|---|---|
| Catalyst | MPa | coal/% | Oil yield/% |
| Example 1 | 12.01 | 84.65 | 56.94 |
| Example 2 | 12.02 | 81.06 | 52.91 |
| Example 3 | 11.99 | 78.24 | 49.37 |
| Example 4 | 12.02 | 80.79 | 51.85 |
| Example 5 | 12.02 | 80.46 | 50.34 |
| Example 6 | 12.01 | 76.84 | 48.76 |
| Example 7 | 12.01 | 76.65 | 47.20 |
| Example 8 | 12.01 | 84.18 | 56.21 |
| Example 9 | 12.01 | 75.13 | 45.85 |
| Example 10 | 12.01 | 75.86 | 46.02 |
| Example 11 | 10.01 | 83.45 | 55.69 |
| Example 12 | 15.02 | 83.77 | 55.82 |
| Comparative | 12.01 | 76.04 | 46.80 |
| example 1 | | | |
| Comparative | 12.03 | 82.11 | 54.08 |
| example 2 | | | |
| Comparative | 12.02 | 75.04 | 44.91 |
| example 3 | | | |
| Comparative | 19.00 | 84.23 | 56.37 |
| example 4 | | | |

It is understood that the above examples of the present disclosure are examples given only for the purpose of clearly illustrating the present disclosure, rather than limitations to the embodiments of the present disclosure. For those ordinarily skilled in the art, different forms of changes or variations can be made based on the above description. All embodiments cannot be listed exhaustively here. Any obvious changes or variations extending from the technical solutions of the present disclosure are within the scope of the spirit covered by the present disclosure.

1. A method for preparing a molybdenum amine complex catalyst, comprising steps of: reacting a hexavalent molybdenum compound with at least one aliphatic amine compound having C4 or more carbon atoms in the presence of a dispersion medium hydrocarbon oil to obtain an active metal catalyst precursor, and uniformly dispersing the active metal catalyst precursor in the dispersion medium hydrocarbon oil to obtain the molybdenum amine complex catalyst.

2. The method for preparing a molybdenum amine complex catalyst according to claim 1, wherein, the hexavalent molybdenum compound is one or more selected from oxides or metal salts of hexavalent molybdenum.

3. The method for preparing a molybdenum amine complex catalyst according to claim 1, wherein, the at least one aliphatic amine compound having C4 or more carbon atoms is selected from C4-C20 aliphatic diamine.

4. The method for preparing a molybdenum amine complex catalyst according to claim 1, wherein, the dispersion medium hydrocarbon oil is a mineral oil with low viscosity and low content of impurity.

5. The method for preparing a molybdenum amine complex catalyst according to claim 1, wherein, the hexavalent molybdenum compound and the aliphatic amine compound are reacted at a temperature between 40° C. and 100° C.

6. A molybdenum amine complex catalyst prepared by the method for preparing a molybdenum amine complex catalyst of claim 1.

7. A molybdenum amine complex catalyst for direct coal liquefaction, which comprises the molybdenum amine complex catalyst of claim 6 uniformly dispersed in a direct liquefaction circulating solvent.

8. A coal oil slurry for direct coal liquefaction, which comprises the molybdenum amine complex catalyst of claim 6, as well as coal powder and a sulfur source, uniformly dispersed in a direct liquefaction circulating solvent.

9. A method for direct coal liquefaction, which comprises a step of: in the presence of a sulfur source and the molybdenum amine complex catalyst of claim 6 uniformly dispersed in a direct liquefaction circulating solvent, subjecting coal powder to direct coal liquefaction reaction.

10. The method for direct coal liquefaction according to claim 9, wherein, the direct coal liquefaction reaction is carried out at a reaction temperature of 450 to 460° C., a reaction pressure of 10 to 15 MPa, and a reaction residence time of 0.5 hour to 2 hours.

11. The method for preparing a molybdenum amine complex catalyst according to claim 2, wherein, the hexavalent molybdenum compound is one or more of sodium molybdate, potassium molybdate, diamine molybdate, ammonium dimolybdate, ammonium tetramolybdate, ammonium heptamolybdate and molybdenum trioxide.

12. The method for preparing a molybdenum amine complex catalyst according to claim 3, wherein, the at least one aliphatic amine compound having C4 or more carbon atoms is one or more of dibutylamine, bis(ethylhexyl)amine, didodecylamine, and ditridecylamine.

13. The method for preparing a molybdenum amine complex catalyst according to claim 4, wherein, the dispersion medium hydrocarbon oil is paraffin oil or naphthenic oil.

14. The method for preparing a molybdenum amine complex catalyst according to claim 5, wherein, the hexavalent molybdenum compound and the aliphatic amine compound are reacted at a temperature of 65° C. to 80° C.

15. The method for preparing a molybdenum amine complex catalyst according to claim 5, wherein, the hexavalent molybdenum compound and the aliphatic amine compound are reacted at 75±1° C.
